(19) United States
(12) Patent Application Publication
(10) Pub. No.: US 2009/0322657 A1
(43) Pub. Date: Dec. 31, 2009

(54) ORGANIC LIGHT EMITTING DISPLAY AND FABRICATING METHOD THEREOF

(75) Inventors: Hyung-Don NA, Seoul (KR); Seok-Je SEONG, Yongin-si (KR); In-Do CHUNG, Yongin-si (KR); Seong-Hyun JIN, Incheong-si (KR); Jin-Gon OH, Yangpyung-gun (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/244,465

(22) Filed: Oct. 2, 2008

(30) Foreign Application Priority Data
Jun. 27, 2008 (KR) 10-2008-0061570

(51) Int. Cl. G09G 3/30

(52) U.S. Cl. 345/76

(57) ABSTRACT

A flat panel display according to an exemplary embodiment of the present invention includes a transistor disposed on a substrate, a planarizing layer having a trench, which includes a bottom surface and a side surface, disposed on the transistor, a reflective film disposed in the trench, a pixel electrode disposed on the reflective film and connected to the transistor, a partition wall having an opening to expose a portion of the pixel electrode, an organic light emitting member disposed on the reflective film, and a common electrode disposed on the organic light emitting member.

### CROSS REFERENCE TO RELATED APPLICATION

This application claims priority from and the benefit of Korean Patent Application No. 10-2008-0061570, filed on Jun. 27, 2008, which is hereby incorporated by reference for all purposes as if fully set forth herein.

### BACKGROUND OF THE INVENTION

1. Field of the Invention

The present invention relates to an organic light emitting display and a fabricating method thereof, and more particularly, to a flat panel display that includes a reflective film, which may improve optical efficiency, and a fabricating method thereof.

2. Discussion of the Background

Among flat panel displays, an organic light emitting display (“OLED”) is advantageous because it may be driven with a low voltage, may be thin and light, may have a wide viewing angle, and may have a relatively short response time. The OLED includes a thin film transistor (“TFT”) having a control electrode, an input electrode, and an output electrode. The OLED also includes a pixel electrode connected to the TFT, a partition wall dividing the pixel electrodes from each other, an organic light emitting member formed on the pixel electrode between the partition walls, and a common electrode formed on the organic light emitting member.

The organic light emitting member includes a light emitting layer to represent at least one color of white, red, green, or, blue. The organic light emitting member can further include at least one of a hole injecting layer, a hole transporting layer, an electron transporting layer, or an electron injecting layer.

The OLED may be a bottom emission type or a top emission type according to the light emission direction. Light is emitted through a substrate having the TFTs in the bottom emission type. Thus, an aperture ratio may decrease due to the TFTs and wire lines in the bottom emission type.

On the other hand, light is emitted through the common electrode in the top emission type. Thus, there may be no decrease of the aspect ratio due to the TFTs.

However, the OLED may have low external quantum efficiency, sometimes less than 20%, regardless of light emission type. Also, the OLED may have low optical efficiency since a portion of the light emitted to the side of the OLED dissipates instead of being directed to the viewing side.

### SUMMARY OF THE INVENTION

The present invention provides a flat panel display that may have increased optical efficiency because light emitted to the side of the display is redirected to a viewing side.

The present invention also provides a method of fabricating the flat panel display.

Additional features of the invention will be set forth in the description which follows, and in part will be apparent from the description, or may be learned by practice of the invention.

The present invention discloses a flat panel display including a transistor disposed on a substrate, a planarizing layer having a trench, which includes a bottom surface and a side surface, on the transistor, a reflective film disposed in the trench, a pixel electrode disposed on the reflective film and connected to the transistor, a partition wall having an opening to expose a portion of the pixel electrode, an organic light emitting member disposed on the pixel electrode, and a common electrode disposed on the organic light emitting member.

The present invention also discloses a method of manufacturing a flat panel display including forming a transistor on a substrate, forming a planarizing layer on the transistor, forming a trench and a contact hole in the planarizing layer, forming a reflective film on the trench, forming a pixel electrode electrically connected to the transistor through the contact hole, forming a partition wall to cover edges of the pixel electrode, forming an organic light emitting member on the pixel electrode, and forming a common electrode on the organic light emitting member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an equivalent circuit of an exemplary flat panel display according to an exemplary embodiment of the present invention.

FIG. 2 is a sectional view of a flat panel display according to an exemplary embodiment of the present invention.

FIG. 3 is a schematic sectional view of an optical path in the flat panel display of FIG.2.

FIG. 4, FIG. 5, FIG. 6, FIG. 7, and FIG. 8 show a method of manufacturing a flat panel display according to an exemplary embodiment of the present invention.

FIG. 9 is a sectional view of an exemplary flat panel display according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

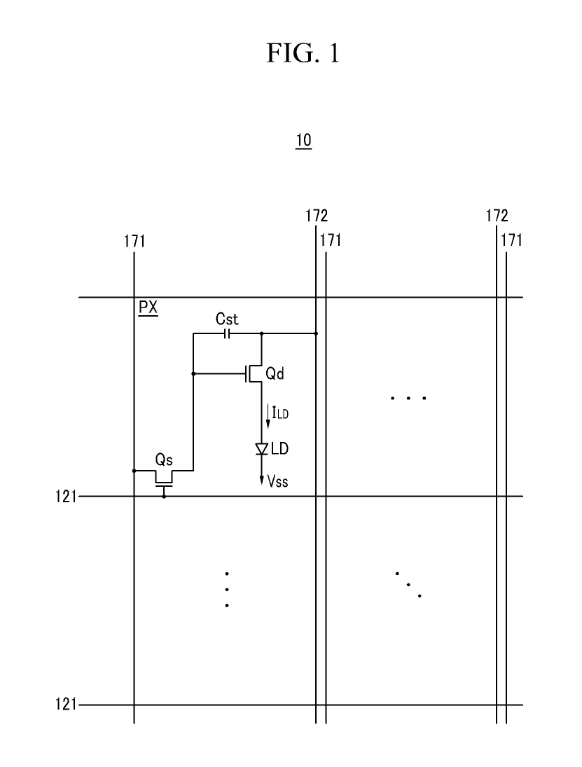

FIG. 1 is an equivalent circuit of an exemplary flat panel display according to an exemplary embodiment of the present invention. Referring to FIG. 1, an OLED 10 according to an exemplary embodiment of the present invention includes a plurality of signal lines 121, 171, and 172, and a plurality of pixels PX arranged in a matrix. The pixels PX are defined by the signal lines 121 171, and 172.

The signal lines include gate lines 121, data lines 171, and driving voltage lines 172. Each gate line 121 transmits a gate signal (i.e. scan signal). Each data line 171 transmits a data signal, and each driving voltage line 172 transmits a driving voltage. The gate lines 121 extend in a row direction and are parallel to each other. The data lines 171 and the driving voltage lines 172 extend in a column direction and are parallel to each other. In other exemplary embodiments, the driving voltage lines may extend in a row direction or be formed in a net structure.

Each pixel PX has a switching transistor Qs, a driving transistor Qd, a storage capacitor Cst, and an organic light emitting element LD.

The switching transistor Qs includes a control terminal, an input terminal, and an output terminal. The control terminal is connected to the gate line 121, and the input terminal is connected to the data line 171. The output terminal is connected to the driving transistor Qd. The switching transistor Qs transmits the data signal received from the data line 171 to the driving transistor Qd in response to the gate signal received from the gate line 121.

The driving transistor Qd includes a control terminal, an input terminal, and an output terminal. The control terminal is connected to the switching transistor Qs, and the input terminal is connected to the driving voltage line 172. The output terminal is connected to the organic light emitting element LD. The output current I_{LD} of the driving transistor Qd is a function of a voltage difference between the control terminal and the output terminal.

The storage capacitor Cst is connected between the control terminal and the input terminal of the driving transistor Qd. The storage capacitor Cst stores the data signal applied to the control terminal of the driving transistor Qd and maintains it after the switching transistor Qs turns off.

The organic light emitting element LD includes a pixel electrode connected to the output of the driving transistor Qd and a common electrode connected to a common voltage Vss. The organic light emitting element LD displays an image depending on the output current I_{LD} of the driving transistor Qd.

The switching transistor Qs and the driving transistor Qd may include an n type transistor. However, at least one of the switching transistor Qs or the driving transistor Qd may be a p type transistor. Also, the connections between the transistors Qs and Qd, the storage capacitor Cst, and the organic light emitting element LD may be changed.

In another exemplary embodiment, more transistors may be formed to compensate a threshold voltage of the driving transistors Qd or the organic light emitting element LD.

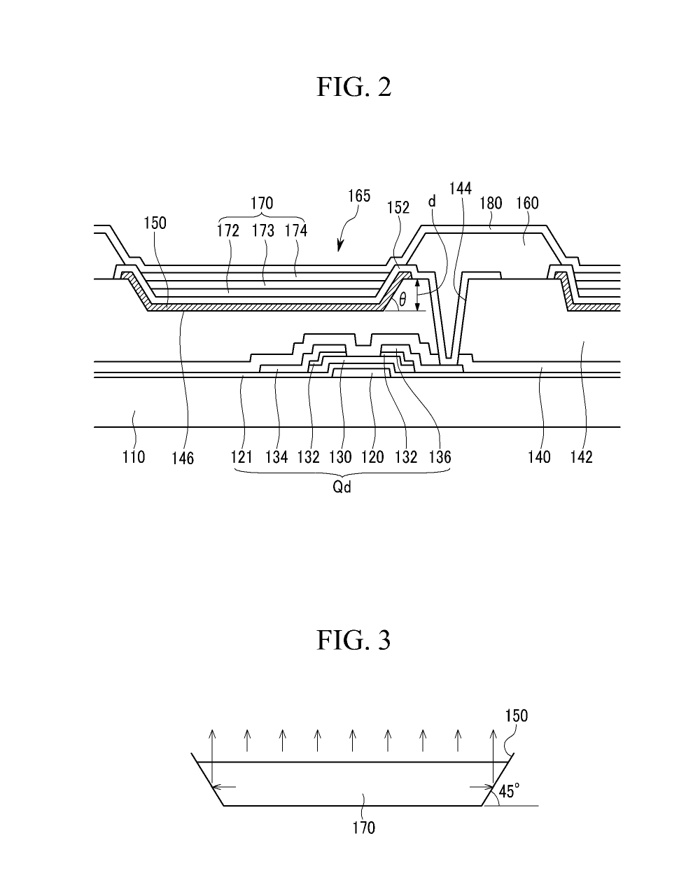

FIG. 2 and FIG. 3 are sectional views of a flat panel display, such as the flat panel display of FIG. 1, according to an exemplary embodiment of the present invention. FIG. 2 shows a single driving transistor Qd of a pixel PX.

Referring to FIG. 2, a control electrode 120 is formed on an insulating substrate 110. The control electrode 120 is connected to a switching transistor, such as the switching transistor Qs of FIG. 1. The insulating substrate 110 may include glass, quartz, ceramic, or plastic.

A gate insulating layer 121 is formed on the insulating substrate 110 and the control electrode 120. The gate insulating layer 121 may include silicon nitride (SiNₓ).

A semiconductor layer 130 is formed on the area corresponding to the control electrode 120. The semiconductor layer 130 may include an amorphous silicon layer or a poly silicon layer. A pair of ohmic contacts 132 is formed on the semiconductor layer 130, and the ohmic contacts 132 are spaced apart from each other with respect to the control electrode 120.

An input electrode 134 and an output electrode 136 are formed on the ohmic contacts 132 and the gate insulating layer 121. The input electrode 134 and the output electrode 136 are spaced apart from each other with respect to the control electrode 120.

The control electrode 120, the gate insulating layer 121, the semiconductor layer 130, the input electrode 134, and the output electrode 136 form the driving transistor Qd.

A passivation layer 140 is formed on the input electrode 134, the output electrode 136, and an exposed portion of semiconductor 130. The passivation layer 140 may include silicon nitride (SiNₓ).

A planarizing layer 142 is formed on the passivation layer 140. The planarizing layer 142 may include an organic material or a photosensitive material. The organic material may include benzocyclobutene (BCB) series, olefin series, acrylic resin series, polyimide series, TEFLON® series, CYTOP®, or perfluorocyclobutane (“FCB”).

The planarizing layer 142 includes a trench 146. The trench 146 may be formed by removing a portion of the planarizing layer 142. The planarizing layer 142 and the passivation layer 140 include a contact hole 144 to expose a portion of the output electrode 136.

The trench 146 includes a relatively flat bottom surface and an inclined side surface, which may form an angle of more than 90 degrees. In other words, the side surface of the trench 146 is inclined at an acute angle θ with respect to the insulating substrate 110. In one exemplary embodiment, the angle θ may range from about 40° and to about 50°. The depth d of the trench 146 may be adapted to the thickness of an organic light emitting member 170. In one exemplary embodiment, the depth d of the trench 146 is 100 nm or more.

A reflective film 150 is formed along the bottom and side surfaces of the trench 146. The thickness of the reflective film 150 may be substantially constant so that an angle between the bottom and the side surfaces of the trench 146 may range from about 130° and to about 140°. The reflective film 150 may extend beyond the trench 146 and be formed on a portion of the planarizing layer 142 adjacent to the trench 146.

The reflective film 150 may include a reflective metal such as molybdenum, chrome, silver, aluminum, or an alloy thereof. The reflective film 150 may further include a buffer layer under the reflective metal. The buffer layer may include indium tin oxide or indium zinc oxide. The buffer layer may enhance adhesion between the reflective metal and the planarizing layer 142. In one exemplary embodiment, the reflective film 150 has reflectivity equal to or more than 70%. The thickness of the reflective film 150 may be from about 50 nm to about 500 nm. When the thickness of the reflective film 150 is less than 50 nm, the reflectivity of the reflective film 150 may decrease. On the other hand, when the thickness of the reflective film 150 is larger than 500 nm, the process time may increase without improving reflectivity.

A pixel electrode 152 is formed on the reflective film 150, the planarizing layer 142, and the contact hole 144. The pixel electrode 152 is connected to the output electrode 136 through the contact hole 144. The pixel electrode 152 is formed to cover the edges of the reflective film 150 according to this exemplary embodiment. The pixel electrode 152 may include indium tin oxide or indium zinc oxide.

A partition wall 160 is formed on the pixel electrode 152 and the planarizing layer 142. The partition wall 160 surrounds the edges of the pixel electrode 152 to define an opening 165. The partition wall 160 may include an organic material or an inorganic material. The partition wall 160 includes a relatively flat bottom surface and an inclined side surface. The side surface of the partition wall 160 may substantially coincide with the prolongation of the inclined surface of the reflective film 150, thereby reducing the partition wall 160 to block optical path and improve reflectivity.

The partition wall 160 may include a photosensitive material, or an inorganic material such as SiO₂ or TiO₂. In an exemplary embodiment, the photosensitive material may include acryl resin or polyimide resin with thermal resistance and solvent resistance. The partition wall 160 may have a double layered structure including an organic layer and an inorganic layer.

An organic light emitting member 170 is formed in the trench 146. The organic light emitting member 170 may include a hole transporting layer 172, a light emitting layer 173, and an electron transporting layer 174. A hole injection layer (not shown) and an electron injection layer (not shown) may be further included between the hole transporting layer 172 and the light emitting layer 173, and between the light emitting layer 173 and the electron transporting layer 174, respectively.

The organic light emitting member 170 may include a small molecular weight material or a polymer.

A thickness of the organic light emitting member 170 may be about 500 Å to about 3,000 Å. The light emitting layer 173 may represent at least one of red, green, blue, or white. Also, the light emitting layer 173 may include sub-layers (not shown) that represent different colors. In one exemplary embodiment, the surface of the light emitting layer 173 may be disposed below the top surface of the planarizing layer 142.

A common electrode 180 is formed on the partition wall 160 and the organic light emitting member 170. The common electrode 180 may include calcium, barium, magnesium, aluminum, silver, or an alloy thereof. The common electrode 180 may have a thickness of about 50 nm to about 200 nm. When the thickness of the common electrode 180 is less than about 50 nm, its resistance may increase excessively so that a common voltage may not be applied smoothly. On the other hand, when it is above about 200 nm, the common electrode 180 may become opaque. In one exemplary embodiment, the optical transmittance of the common electrode 180 may be greater than 50%.

Referring to FIG. 3, light emitted from the light emitting layer 173 radiates outwardly through the common electrode 180. A portion of the light emitted from the light emitting layer 173 radiates downward. The bottom surface of the reflective film 150 reflects light outward and toward the side surface of the trench 146. Incident light on the side surface is reflected outwardly by the reflective film 150, thereby increasing optical efficiency.

In an exemplary embodiment, when the angle θ between the side surface of the trench 146 and the insulating substrate 110 is about 40 degrees to 50 degrees, the light reflected by the reflective film 150 progresses in a direction perpendicular to the insulating substrate 110. Thus, optical efficiency may improve. Also, the surface of the light emitting layer 173 may be disposed below the surface of a portion of the planarizing layer 142 that does not include the trench 146, which may more effectively increase the optical efficiency.

A protective layer (not shown), a moisture absorption film, or other similar layers may be formed on the top of the common electrode 180. An encapsulation member such as glass may be further included.

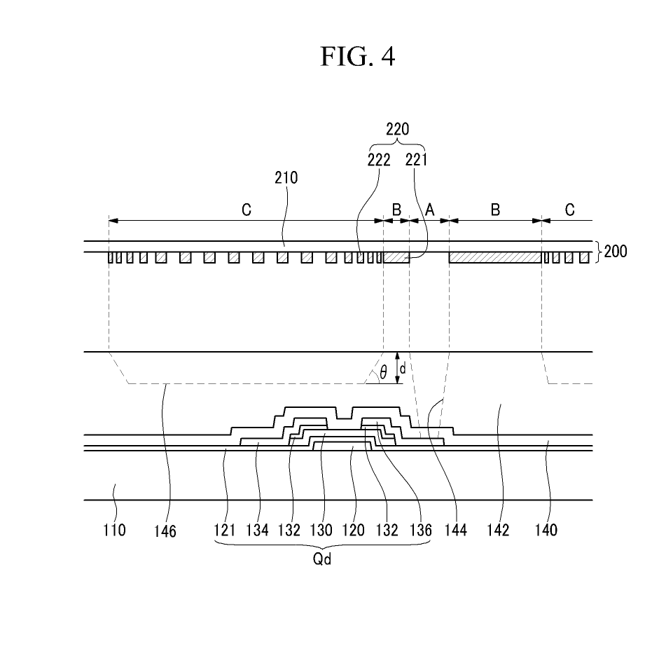

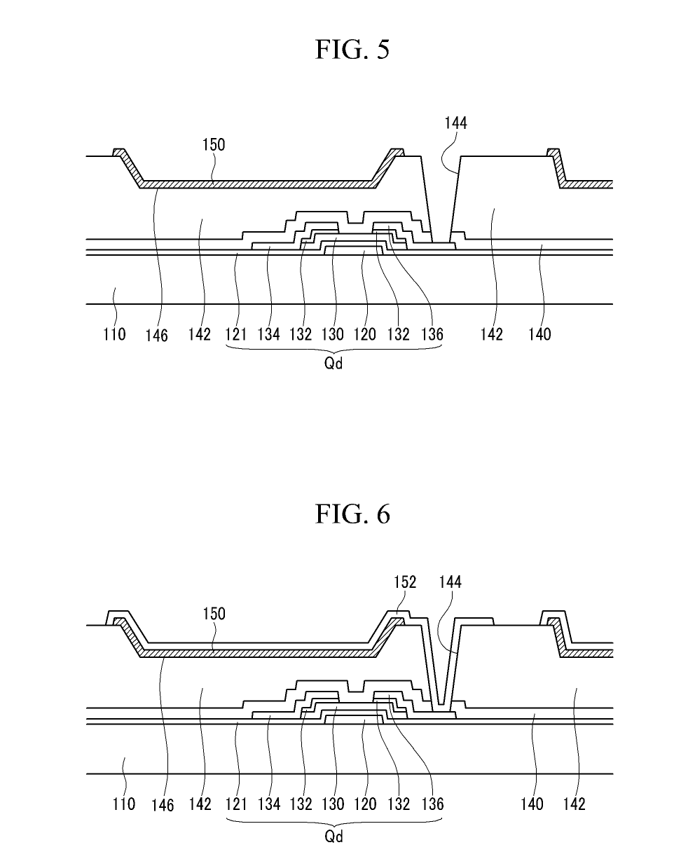

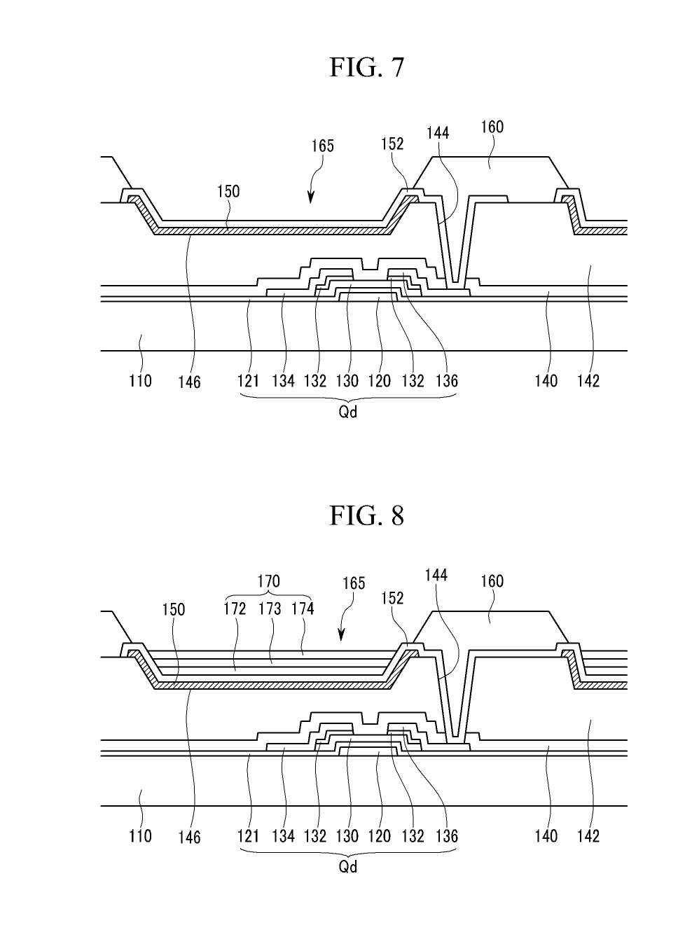

FIG. 4, FIG. 5, FIG. 6, FIG. 7, and FIG. 8 show a method of manufacturing a flat panel display of FIG. 2 according to an exemplary embodiment of the present invention.

Referring to FIG. 4, a driving transistor Qd is formed on an insulating substrate 110. The driving transistor Qd includes a channel, which may be formed of amorphous silicon or poly silicon.

A passivation layer 140 and a planarizing layer 142 are formed on the driving transistor Qd.

The passivation layer 140 may include silicon nitride and may be formed by chemical vapor deposition. The planarizing layer 142 may include a photosensitive material and may be formed by slit coating or spin coating.

A mask 200 is disposed over the planarizing layer 142, through which the planarizing layer 142 is exposed to light such as ultra violet.

The mask 200 includes a base 210 and a light blocking layer 220 on the base 210. The base 210 may include quartz. The light blocking layer 220 prevents ultra violet light from transmitting therethrough. The light blocking layer 220 includes a wide portion 221 and a narrow portion 222. The narrow portion is not as wide as the wide portion 221. The mask 200 includes a transmissive area A, a reflective area B, and a transflective area C.

The transmissive area A corresponds to the area where the contact hole 144 of FIG. 2 is formed. The transmissive area A includes no light blocking layer, thereby exposing the planarizing layer 142 to light.

The reflective area B corresponds to the area where the partition wall 160 of FIG. 2 is formed, and includes the wide portion 221. Thus, the planarizing layer 142 in the area corresponding to the reflective area B is not exposed to light.

The transflective area C corresponds to the area where the trench 146 of FIG. 2 is formed. The transflective area C includes intervals between the narrow portions 222, through which light may be transmitted. Light is transmitted through the transflective area C, and an upper portion of the planarizing layer 142 is exposed to light. The interval between the narrow portions 222 may be adapted to the thickness of the planarizing layer 142. The width of the narrow portions 222, as well as the interval between the narrow portions 222, may vary across region C. The greater the distance between the narrow portion 222 and the wide portion 221, the wider the interval between the narrow portions 222, thereby controlling the angle θ.

A portion of planarizing layer 142 exposed to light is dissolved during a developing process. Accordingly, while the planarizing layer 142 in the area corresponding to the transmissive area A is removed to expose the passivation layer 140, the planarizing layer 142 in the area corresponding to the reflective area B remains. The planarizing layer 142 in the area corresponding to the transflective area C is dissolved in the upper part and remains in the lower part.

After developing and curing the planarizing layer 142 at a temperature of 200° C. to 300° C., the planarizing layer 142 with position-dependent thickness is completed. That is, the planarizing layer 142 with the trench 146 of FIG. 2 is formed.

In the above example, photolithography is used to form the trench 146, but an imprint process may be used instead.

Referring to FIG. 5, the exposed planarizing layer 142 is removed by an etching process to form a contact hole 144 to expose a portion of an output electrode 136.

A metal layer is deposited on the planarizing layer 142 and patterned to form a reflective film 150 on the trench 146. The metal layer may include molybdenum, chrome, silver, aluminum, or alloy thereof. The reflective film 150 is formed on a bottom surface and a side surface of the trench 146, and may extend beyond the trench 146 to be formed on a portion of the planarizing layer 142 adjacent to the trench 146.

Referring to FIG. 6, a transparent conductive film is formed on the reflective film 150, the contact hole 144, and the planarizing layer 142 by a sputtering method and patterned to form a pixel electrode 152. The transparent conductive film may include indium tin oxide or indium zinc oxide.

The pixel electrode 152 covers the whole surface of the reflective film 150.

Referring to FIG. 7, a photosensitive material is deposited on a portion of the pixel electrode 152 and the planarizing layer 142 and patterned to form a partition wall 160. The partition wall 160 covers edges of the pixel electrode 152. The partition wall 160 includes an opening 165 to expose the pixel electrode 152 and electrically separates the pixel electrodes 152 from one another. In an exemplary embodiment, the partition wall 160 may be formed on the contact hole 144.

An angle between the side surface of the partition wall 160 and the insulating substrate 110 is substantially similar to the angle θ between the side surface of the trench 146 and the insulating substrate 1 10. The side surface of the partition wall 160 substantially coincides with the extension of the reflective film 150. Accordingly, the opening 165 is disposed in the area corresponding to the trench 150.

Referring to FIG. 8, an organic material may be evaporated using a mask or dispensed using an ink jet to form an organic light emitting member 170 in the opening 165. The organic light emitting member 170 may include a hole transporting layer 172, a light emitting layer 173, and an electron transporting layer 174. In one exemplary embodiment, the light emitting layer 173 is disposed below the top surface of the planarizing layer 142.

Referring to FIG. 2, a metal layer is deposited on the organic light emitting member 170 and the partition wall 160 and patterned to form a common electrode 180. The metal layer may include calcium, barium, magnesium, aluminum, silver or alloy thereof. The common electrode 180 may have a thickness of about 50 μm to about 200 μm.

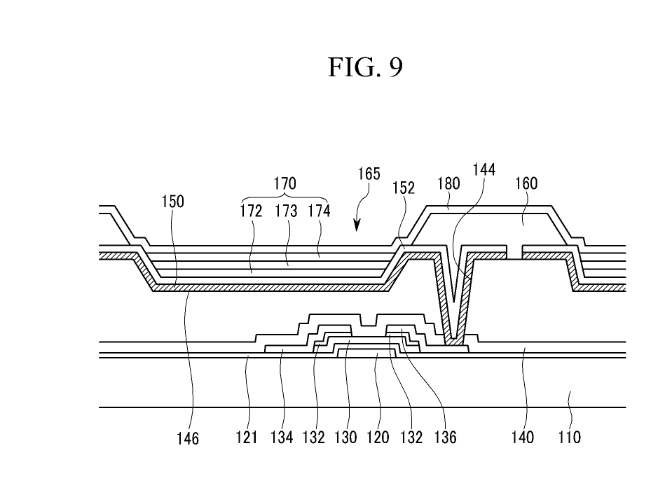

FIG. 9 is a sectional view of a exemplary flat panel display according to another exemplary embodiment of the present invention. This exemplary embodiment is substantially identical to the exemplary embodiment shown in FIG. 2 except the reflective film 150.

Referring to FIG. 9, a reflective film 150 has the same shape as a pixel electrode 152. The edges of the reflective film 150 coincide with the edges of the pixel electrode 152. Referring to FIG. 5 and FIG. 6, the pixel electrode 152 is formed after the formation of the reflective film 150. Alternatively, a metal layer and a transparent conductive film may be sequentially deposited and simultaneously patterned, thereby simultaneously forming the reflective film 150 and the pixel electrode 152 as shown in FIG. 9. Accordingly, the manufacturing cost and time may be decreased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A flat panel display, comprising:
a transistor on a substrate;
a planarizing layer having a trench on the transistor, the trench comprising a bottom surface and a side surface to form an angle;
a reflective film disposed in the trench;
a pixel electrode disposed on the reflective film and connected to the transistor;
a partition wall having an opening to expose a portion of the pixel electrode;
an organic light emitting member disposed on the pixel electrode; and, a common electrode disposed on the organic light emitting member.

2. The flat panel display of claim 1, wherein the opening is disposed in an area corresponding to the trench.

3. The flat panel display of claim 2, wherein the reflective film covers the bottom surface and the side surface.

4. The flat panel display of claim 3, wherein the reflective film comprises a reflective metal.

5. The flat panel display of claim 4, wherein the reflective metal comprises molybdenum, chrome, silver, aluminum, or an alloy thereof.

6. The flat panel display of claim 5, further comprising a buffer layer between the reflective film and the planarizing layer.

7. The flat panel display of claim 6, wherein the buffer layer comprises indium tin oxide or indium zinc oxide.

8. The flat panel display of claim 3, wherein the reflective film has a thickness in the range of 50 nm to 500 nm.

9. The flat panel display of claim 3, wherein the reflective film has a reflectivity equal to or greater than 70%.

10. The flat panel display of claim 3, wherein an angle between the side surface and the bottom surface is in the range of 130 to 140 degrees.

11. The flat panel display of claim 1, wherein the planarizing layer comprises an organic material.

12. The flat panel display of claim 1, wherein the planarizing layer comprises a photosensitive material.

13. The flat panel display of claim 1, wherein the trench has a depth equal to or greater than 100 nm.

14. The flat panel display of claim 1, wherein the organic light emitting member comprises a light emitting layer, and the light emitting layer is disposed below a top surface of a portion of the planarizing layer that does not include the trench.

15. The flat panel display of claim 1, wherein edges of the reflective film coincide with edges of the pixel electrode.

16. A method of manufacturing a flat panel display, comprising:
forming a transistor on a substrate;
forming a planarizing layer on the transistor;
forming a trench and a contact hole in the planarizing layer;
forming a reflective film on the trench;
forming a pixel electrode connected to the transistor through the contact hole;
forming a partition wall to cover edges of the pixel electrode;
forming an organic light emitting member on the pixel electrode; and, forming a common electrode on the organic light emitting member.

17. The method of claim 16, wherein forming the trench and the contact hole comprises:
disposing a mask having a transflective area and a transparent area on the planarizing layer;
exposing the planarizing layer to light through the mask; and,
developing the exposed planarizing layer,
wherein the transflective area and the transparent area are located in areas corresponding to the trench and the contact hole, respectively.

18. The method of claim 17, wherein the mask further comprises a blocking area in an area corresponding to the partition wall.

19. The method of claim 18, wherein the transflective area comprises narrow portions having narrower intervals therebetween as the narrow portions approach the blocking area.

20. The method of claim 16, wherein the reflective film and the pixel electrode are patterned simultaneously.
